(19) United States
(12) Patent Application Publication
(10) Pub. No.: US 2025/0363206 A1
(43) Pub. Date: Nov. 27, 2025

(54) DATA SECURITY MANAGEMENT

(71) Applicant: Honeywell International Inc., Charlotte, NC (US)

(72) Inventors: Ravikumar Selvarajan, Madurai (IN); Sreenivasan Govindillam, Bangalore (IN); Philip Toews, Phoenix, AZ (US)

(21) Appl. No.: 18/672,007

(22) Filed: May 23, 2024

(51) Int. Cl. G06F 21/54; G06F 21/57; G06F 21/64

(52) U.S. Cl. CPC G06F 21/54; G06F 21/577; G06F 21/64

(57) ABSTRACT

Techniques for managing security of data of EFB applications to be used with avionics are described. In one example implementation, the present subject matter facilitates in determining if one or more of the plurality of EFB applications are compromised by performing a validity test on the uncertified data and further applying an isolation and neutralization technique only on the one or more compromised EFB applications.

### BACKGROUND

Aerial vehicles, such as passenger aircrafts, cargo aircrafts, fighter aircrafts, artificial satellites, and spacecrafts, etc., generally comprise avionics that performs various functions, for example, communication, navigation, display, and data management. The avionics installed in the aerial vehicles may include, but is not limited to, flight management systems, engine controls, flight control systems, navigation, communications, flight recorders, lighting systems, threat detection, fuel systems, electro-optic systems, weather radar, etc. For example, the flight management system may collect, manage, protect, and store data such as flight path, a traffic diversion status, a cargo weight, etc, to perform functioning such as flight plan, position determination, guidance, vertical navigation etc.

### SUMMARY OF INVENTION

This summary is provided to introduce concepts related to managing data security of Electronic Flight Bag (EFB) applications to be used with avionics. This summary is not intended to identify essential features of the claimed subject matter nor is it intended for use in determining or limiting the scope of the claimed subject matter.

In an aspect of the present subject matter, a method for determining a compromised EFB application, and isolating and neutralizing the determined compromised EFB application is disclosed. The method includes receiving uncertified data from each of a plurality of EFB applications. The uncertified data is associated with at least one of flight assistance parameters of an aircraft. Further, in the method, the certified aviation data is received from a flight management system of the aircraft. The method further includes determining if one or more of the plurality of EFB applications are compromised by performing a validity test on the uncertified data. For the one or more compromised EFB applications, an isolation and neutralization technique is applied for preventing transmission of the compromised uncertified data to the flight management system of the aircraft. For the one or more EFB applications determined to be not compromised, flight modification parameters are calculated using the certified aviation data and the uncertified data of the one or more EFB applications and the flight modification parameters are further transmitted to the flight management system of the aircraft.

In another aspect of the present subject matter, a system for determining a compromised EFB application, isolating and neutralizing the determined compromised EFB application, and masking a portion of the certified aviation data before transmitting the same to the one or more EFB applications determined to be not compromised is disclosed. The system includes a validation engine, a masking engine, and a flight parameter generation engine. The validation engine may receive uncertified data from each of a plurality of EFB applications and determine if one or more of the plurality of EFB applications are compromised by performing a validity test on the uncertified data. The uncertified data may be associated with at least one of flight assistance parameters of an aircraft. For the one or more compromised EFB applications, the validation engine may apply an isolation and neutralization technique for preventing transmission of the compromised uncertified data to a flight management system of the aircraft. Further, the masking engine may receive certified aviation data from the flight management system of the aircraft, and mask, at least a portion of the certified aviation data to provide controlled access of the certified aviation data to the one or more EFB applications determined to be not compromised. The masking engine may use a masking technique for masking the certified aviation data. Further, the flight parameter generation engine may calculate flight modification parameters using unmasked portion of the certified aviation data and the uncertified data.

In yet another aspect of the present subject matter, a non-transitory computer readable medium for determining a compromised EFB application, and isolating and neutralizing the determined compromised EFB application is disclosed. The non-transitory computer readable medium has instructions stored thereon. The instructions, when executed by a processor, cause the processor to perform operations. In the operations, uncertified data from each of a plurality of EFB applications and certified aviation data from a flight management system of the aircraft nay be received. The uncertified data is associated with at least one of flight assistance parameters of an aircraft. Further, in operation, a validity test may be performed on the uncertified data to determine if one or more of the plurality of EFB applications are compromised. Yet further, in the operations, for the one or more compromised EFB applications, an isolation and neutralization technique may be applied for preventing transmission of the compromised uncertified data to the flight management system, and for the one or more EFB applications determined to be not compromised, flight modification parameters may be calculated using the certified aviation data and the uncertified data of the one or more EFB applications. Further, in operation, the flight modification parameters may be transmitted to the flight management system of the aircraft.

### BRIEF DESCRIPTION OF FIGURES

Systems and/or methods, in accordance with examples of the present subject matter are now described and with reference to the accompanying figures, in which:

FIG. 1 illustrates a system for managing security of data of Electronic Flight Bag (EFB) applications to be used with avionics, according to an example;

FIG. 2 illustrates a network environment for managing security of data of Electronic Flight Bag (EFB) applications to be used with avionics, according to an example;

FIG. 3 illustrates a method for managing security of data of Electronic Flight Bag (EFB) applications to be used with avionics, according to an example;

FIG. 4 illustrates an exemplary validity test, according to an example;

FIG. 5 illustrates an exemplary validity test, according to another example;

FIG. 6 illustrates an exemplary validity test, according to another example;

FIG. 7 illustrates an exemplary isolation and neutralization technique, according to an example;

FIG. 8 illustrates an exemplary isolation and neutralization technique, according to another example;

FIG. 9 illustrates a method for managing security of data of Electronic Flight Bag (EFB) applications to be used with avionics, according to another example;

FIG. 10A illustrates an environment where an aircraft is at a runway before takeoff, according to an example;

FIG. 10B illustrates an environment where an aircraft is flying and simultaneously interacting with a ground fleet service platform located at ground, according to an example; and

FIG. 11 illustrates a non-transitory computer readable medium for managing security of data of Electronic Flight Bag (EFB) applications to be used with avionics, according to an example.

### DETAILED DESCRIPTION

In recent years, avionics have become increasingly interconnected, both internally and with external open-source systems, such as, an electronic flight bag (EFB) which is an external management device to assist flight crews in flight management. The EFB may include EFB applications containing data that may include flight assistance parameters of an aerial vehicle, such as real-time weather details, navigational charts, and other data such as flight crew operating manuals, etc. Such interconnectivity allows for more efficient operation and management of the aircraft. However, data in the EFB applications is from an open-source environment and is therefore uncertified unlike data of the avionics, which is certified. The uncertified data of one or more of the EFB application may be compromised, for example, due to virus attack and as a result the one or more of the EFB applications is also compromised. When any compromised EFB application interconnects with the avionics to share the uncertified data, possibilities of potential vulnerabilities, for example, cyber threats open for the avionics, thereby affecting integrity, functionality, availability, and robustness of the avionics. For example, incorrect navigation chart may cause unnecessary delay in a flight by modifying a flight path of the aerial vehicle.

In a conventional solution, when the one or more of the EFB applications are suspected to be compromised based on irregularity observed in the functioning the avionics, all the EFB applications communicating with the avionics may be terminated. However, this termination will also include the termination of the EFB applications, which are not compromised and the data of such EFB applications may be utilized by the avionics for effective operation of the aerial vehicle. Thus, the efficiency of the avionics is affected.

The present subject matter describes approaches for managing security of data of Electronic Flight Bag (EFB) applications to be used with avionics. In an example, the present subject matter discloses receiving uncertified data from each of a plurality of Electronic Flight Bag (EFB) applications. The EFB applications may be included in a portable electronic device such as a laptop or tablet which may be connected to a network. The uncertified data is associated with at least one of flight assistance parameters of the aircraft, such as, real-time weather information which may be obtained from the network. Further, certified aviation data may be received from a flight management system of the aircraft. In an example, the flight management system of the aircraft is at least one of an onboard flight management system located onboard the aircraft or a remote flight management system located remotely from the aircraft, and the certified aviation data is received from at least one of the onboard flight management system onboard or the remote flight management system.

After receiving the uncertified data, a validity test is performed the uncertified data for determining if one or more of the EFB applications are compromised, i.e., to determine if the one or more EFB applications contain uncertified data that may include a malicious program, modified data, etc., which on execution may cause irregularity in the functioning of the avionics, i.e. flight management system. In an example, the validity test may be one of a startup test, a continuous test, and an interactive test. Such a validity test may be initiated manually by a user, i.e. pilot of the aircraft or may be initiated automatically when the portable device connects to the flight management system.

On determining, based on the validity test, if the one or more EFB applications are compromised, an isolation and neutralization technique is applied to the compromised EFB applications. On isolation and neutralization of the compromised EFB applications, it is ensured that transmission of the compromised uncertified data to the flight management system of the aircraft is prevented. Further, flight modification parameters are calculated using the certified aviation data and the uncertified data of the uncompromised EFB applications. The flight modification parameters are transmitted to the flight management system of the aircraft for continuing optimal flight operation of the aircraft.

In another example implementation, for the one or more EFB applications determined to be not compromised, certified aviation data is received from the flight management system and a portion of the certified aviation data is masked to provide controlled access of the certified aviation data to the uncompromised EFB applications. Further, flight modification parameters are calculated using unmasked portion of the certified aviation data and the uncertified data of the uncompromised EFB applications. The masking ensures that only relevant portion of the certified aviation data is available at the EFB applications for further processing. This further enhances the security of the certified aviation data of the flight management system, i.e. avionics. The flight modification parameters are transmitted to the flight management system of the aircraft for continuing optimal flight operation of the aircraft.

The present invention thus allows effective determination of the compromised EFB applications based on the validity test and only isolating and neutralizing the compromised EFB applications while keeping the uncompromised EFB applications being functional. As a result, the efficiency of the avionics is not affected despite some of EFB applications being compromised. In addition, the masking technique of the present invention provides enhanced security to the certified data of the avionics which interacts with the uncompromised EFB applications.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

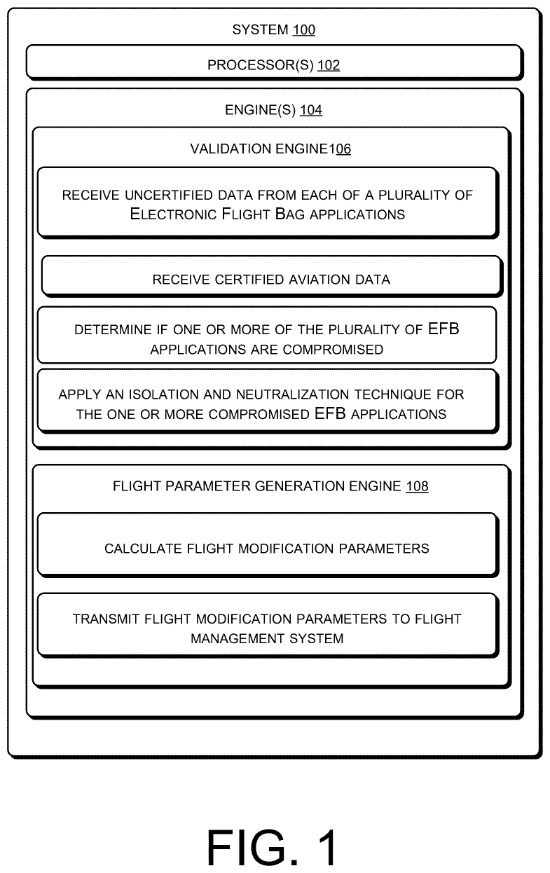

FIG. 1 illustrates a system 100 for managing security of data of EFB applications (not shown in FIG. 1) to be used with avionics installed in an aerial vehicle (not shown in FIG. 1), according to an example. Examples of the system 100 may include, but are not limited to, a laptop, a notebook computer, a server computer, a tablet computer, and a smartphone. The system 100 may include processor(s) 102. The processor(s) 102 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labelled as “processor(s)”, may be provided through the use of dedicated hardware as well as hardware capable of executing computer-readable instructions. In one example, the system 100 may be a standalone server or may be a remote server on a cloud computing platform. In a preferred example, the system 100 may be a cloud-based system. The system 100 is capable of delivering applications (such as cloud applications) for managing an aerial vehicle environment. The EFB may be an external management device, such as a portable electronic device, to assist flight crews in flight management. Examples of the one or more avionics installed in the aerial vehicles may include, but is not limited to, flight management systems, engine controls, flight control systems, navigation, communications, flight recorders, lighting systems, threat detection, fuel systems, electro-optic systems, weather radar, etc. Each of the plurality of the EFBs may include one or more EFB applications. The system 100 may connect with a plurality of EFBs and one more avionics.

The system 100 may further include engine(s) 104. The engine(s) 104 may be implemented as a combination of hardware and programming, for example, programmable instructions to implement a variety of functionalities of the engine(s) 104. In examples described herein, such combinations of hardware and programming may be implemented in several different ways. For example, the programming for the engine(s) 104 may be executable instructions. Such instructions may be stored on a non-transitory machine-readable storage medium which may be coupled either directly with the system 100 or indirectly (for example, through networked means). In an example, the engine(s) 104 may include a processing resource, for example, either a single processor or a combination of multiple processors, to execute such instructions. In other examples, the engine(s) 110 may be implemented as electronic circuitry. The engine(s) 104 includes a validation engine 106 and a flight parameter generation engine 108.

In operation, once the EFBs are connected to the system 100, the system 100 may receive data from the EFB applications present in the plurality of the EFBs. In an example, the plurality of EFBs may connect to system 100 physically, such as, using Universal Serial Bus (USB) cable. In an example, the plurality of EFBs may connect to system 100, via a network such as Wi-Fi network.

Initially, the validation engine 106 of the system 100 may receive the uncertified data from each of the EFBs. Upon receiving the uncertified data, the validation engine 106 performs a validation test on the uncertified data to determine if the uncertified data is compromised, i.e., includes a malicious program, a virus, modified data, and/or any suspicious data. Examples of suspicious data may include a file having a file size different than that of predetermined file size.

In an example, the validity test may be a startup test. In the startup test, the system 100 automatically performs a determination of compromised data on the uncertified data received from the plurality of EFBs once the system 100 is turned on. In an example, the validity test may be a continuous test. In the continuous test, determination of compromised data may take place continuously depending on the received data. For example, during the operation the system 100 will receive updated uncertified data from the plurality of EFBs, such as, updated weather details at different time periods. Upon receiving the updated uncertified data, the system 100 may run the continuous test, while simultaneously operating, to determine if the uncertified data is compromised. In another example, the validity test may be an interactive test. In the interactive test, the user, such as the pilot, flight crew, may provide an input to initiate the validity test to determine if the uncertified data is compromised. The interactive test provides the user to initiate the validity test manually at any instant.

In an example, the validation engine 106, during the validity test, may compare file size of the uncertified data received from the plurality of EFBs with a predetermined file size. For example, the validation engine 106 may compare a file size of a document with a predetermined file size and determines the document to be compromised if the file size is smaller than the predetermined file size.

Upon determining that the uncertified data from the one or more EFB applications are compromised, the validation engine 106 of the system 100 applies an isolation and neutralization technique on the one or more EFB applications whose uncertified data are compromised. In an example, the isolation and neutralization technique may be a technique that stops the one or more EFB applications which are containing uncertified data that are compromised. For example, the EFB application may be a weather forecast application that may contain a virus. Upon determination of the uncertified data obtained from the weather forecast application to be compromised data, the validation engine 106 may stop the working of the weather forecast application to restrict the receiving of the uncertified data from the weather forecast application.

Further, in operation, the validation engine 106 receives certified aviation data from the one or more avionics and transmits the certified aviation data to the flight parameter generation engine 108. In an example, the one or more avionics is the flight management system of the aircraft. The flight management system is at least one of an onboard flight management system located onboard the aircraft or a remote flight management system located remotely from the aircraft, and the certified aviation data is received from at least one of the onboard flight management system onboard or the remote flight management system.

The flight parameter generation engine 108 calculates flight modification parameters based on the uncertified data which are determined not to be compromised and the certified avionic data received from the one or more avionics. The flight modification parameters optimize the operation and management of the aerial vehicle. For example, the flight parameter generation engine 108 calculates flight modification parameters based on the uncertified data which are not compromised, such as real-time weather data. Based on the real-time weather data and the certified avionic data received from the one or more avionics, such as flight management system, flight modification parameters are calculated to optimize the operation and management of the aerial vehicle. In an example, the flight modification parameters may comprise at least one of an increase in speed, a decrease in speed, an increase in altitude, a decrease in altitude, and a change in flight route of the aerial vehicle. The flight parameter generation engine 108 further transmits the flight modification parameters to the flight management system of the aerial vehicle so that the aerial vehicle may operate in an optimized manner.

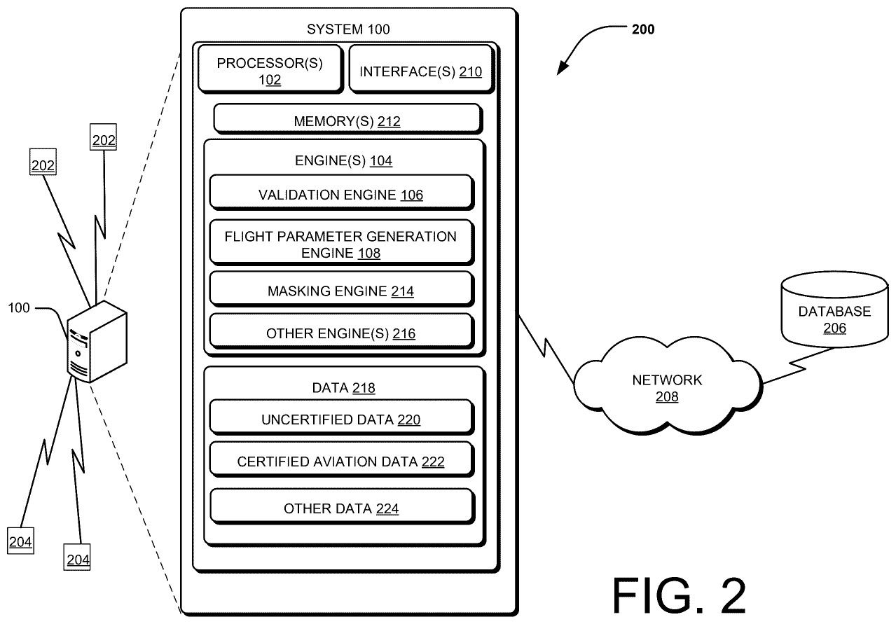

FIG. 2 illustrates a network environment 200 for managing security of data of Electronic Flight Bag (EFB) applications to be used with avionics installed in an aerial vehicle, according to an example. The network environment 200 includes the system 100 for managing security of data of a plurality of EFB applications to be used with avionics 202, in the aerial vehicle (not shown in FIG. 2). The system 100 is described in FIG. 1 and may include, but is not limited to, a laptop, a notebook computer, a server computer, a tablet computer. The EFB applications reside in an EFB 204. The EFB may be an external management device, such as a portable electronic device, to assist flight crews in flight management. The avionics 202 are electronics used in aviation and are installed in the aerial vehicles. The avionics 202 may include, but is not limited to, flight management systems, engine controls, flight control systems, navigation, communications, flight recorders, lighting systems, threat detection, fuel systems, electro-optic systems, weather radar, etc. The system 100 may connect with the plurality of EFBs 204 and multiple avionics 202. The system 100 may include the processor(s) 102 similar to depicted in FIG. 1. Further, in an example, the system 100 may be connected to a database 206 through a network 208. The database 206 may be, for example, a structured query language (SQL) data store or a not only SQL (NoSQL) data store. In an exemplary implementation, the database 202 may be configured as cloud-based database implemented in the aviation environment. In another exemplary implementation, the database 206 may be a location on a file system directly accessible by the engines. The database 206 may be configured to store data of the EFB applications and data of the avionics engineering project files, program files, object behavior model, parameter values associated with the one or more assets and processes and the like.

The network 208 may be a wireless network, a wired network, or a combination thereof. The network 208 can also be an individual network or a collection of many such individual networks, interconnected with each other and functioning as a single large network, e.g., the Internet or an intranet. The network 208 can be implemented as one of the different types of networks, such as intranet, local area network (LAN), wide area network (WAN), the internet, and such. The network 208 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other.

In one implementation, the network environment 200 may be an aviation network, including personal computers, laptops, various servers, such as blade servers, and other computing devices connected over the network 208. The system 100 includes the processor(s) 102. Further, the system 100 includes interface(s) 210 and memory(s) 212. The interface(s) 210 may allow the connection or coupling of the system 100 with one or more other devices, through a wired (e.g., Local Area Network, i.e., LAN) connection or through a wireless connection (e.g., Bluetooth®, Wi-Fi). The interface(s) 210 may also enable intercommunication between different logical as well as hardware components of the system 100.

The memory(s) 212 may be a computer-readable medium, examples of which include volatile memory (e.g., RAM), and/or non-volatile memory (e.g., Erasable Programmable read-only memory, i.e., EPROM, flash memory, etc.). The memory(s) 212 may be an external memory, or internal memory, such as a flash drive, a compact disk drive, an external hard disk drive, or the like. The memory(s) 212 may further include data which either may be utilized or generated during the operation of the system 100.

The engine(s) 104 of the system 100 may further include a masking engine 214 and other engines 216 in addition to the validation engine 106 and the flight parameter generation engine 108 as depicted in FIG. 1. The masking engine 214 and the other engine(s) 216 may be implemented as a combination of hardware and programming, for example, programmable instructions to implement a variety of functionalities of the engine(s). In examples described herein, such combinations of hardware and programming may be implemented in several different ways. For example, the programming for the engine(s) may be executable instructions. Such instructions may be stored on a non-transitory machine-readable storage medium which may be coupled either directly with the system 100 or indirectly (for example, through networked means). In an example, the engine(s) may include a processing resource, for example, either a single processor or a combination of multiple processors, to execute such instructions. In other examples, the engine(s) may be implemented as electronic circuitry. The system 100 may further include data 218.

Each of the plurality of EFBs 204 may include one or more EFB applications. In an example, one of the one or more EFB applications may be a weather application that provides real-time details such as weather details, wind profile etc. In another example, one of the one or more EFB applications may be a documentation application that provides details such as aircraft configuration, gear system information, instrument flight rules (IFR) plan, navigation maps etc. The one or more EFB applications may be included in a portable electronic device such as a laptop or tablet which may be connected to a network. The data of the one more EFB applications may be from an open-source environment. Such open-source data may include a malicious program, modified data, etc., which on execution may cause irregularity in the functioning of the avionics and are therefore not a valid data. The open-source data from the one or more EFB applications are hereinafter referred to as uncertified data 220. The data of the one or more avionics 202 are data obtained from the aerial vehicle itself and is authentic. The data obtained from the one or more avionics 202 are hereinafter referred to as certified aviation data 222. In an example, certified aviation data may comprise at least one of a flight path, a traffic diversion status, minimum equipment list constraints, a cargo weight, and an estimate time of arrival of the aircraft at a stopover airport. The system 100 manages the security of data of EFB applications that are to be used with the avionics 202. In another example, the one or more EFB applications may include other data 224 such as flight crew operating manuals, etc.

The system environment 200 is in operation once the EFBs 204 are connected to the system 100. The EFB applications of the plurality of the EFBs 204 have data relevant to the avionics 202 and such data may be received by the validation engine 106 of the system 100. In an example, the plurality of EFBs 204 may connect to system 100 wired or wirelessly depending on the environment requirements.

Initially, the validation engine 106 of the system 100 may receive the uncertified data 220 from each of the plurality of EFBs 204. Upon receiving the uncertified data 220, the validation engine 106 may perform a validation test on the uncertified data 220 to determine if the uncertified data 220 is compromised, i.e., includes a malicious program, a virus, modified data, and/or any suspicious data. Examples of suspicious data may include a file having a file size different than that of predetermined file size.

In an example, the validity test may be a startup test. In the startup test, the system 100 automatically performs a determination of compromised data on the uncertified data 220 received from the plurality of EFBs 204 once the system 100 is turned on. In an example, the validity test may be a continuous test. In the continuous test, determination of compromised data may take place continuously depending on the received data. For example, during the operation the system 100 will receive updated uncertified data 220 from the plurality of EFBs 204, such as updated weather details at different time periods. Upon receiving the updated uncertified data 220, the system 100 may run the continuous test, while simultaneously operating, to determine if the uncertified data 220 is compromised. In another example, the validity test may be an interactive test. In the interactive test, the user, such as the pilot, flight crew, may provide an input to initiate the validity test to determine if the uncertified data 220 is compromised. The interactive test provides the user to initiate the validity test manually at any instant.

In an example, the validation engine 106, during the validity test, may compare file size of the uncertified data 220 received from the plurality of EFBs 204 with a predetermined file size. For example, the validation engine 106 may compare a file size of a document with a predetermined file size and determines the document to be compromised if the file size is smaller than the predetermined file size. In another example, the validation engine 106 may request the one or more EFB applications to send a specific sequence of protocol handshaking, such as, transmission control protocol (TCP), thereby establishing the validity of the uncertified data 220. In another example, the validation engine 106 may request the one or more EFB applications to share a special code to establish the validity of the uncertified data 220. In an example, the special code may be a one-time password. In another example, the validation engine 106 may determine a validation setting. The validation setting being one of a manual validation setting and an auto validation setting. When the validation setting is manual validation setting, the validation engine 106 performs the validity test on receiving a prompt from the user. When the validation setting is auto validation setting, the validation engine 106 performs the validity test automatically during a startup of a flight operation of the aerial vehicle.

Upon determining that the uncertified data 220 from the one or more EFB applications are compromised, i.e., the EFB application having compromised data is also determined to be compromised. Further, the validation engine 106 of the system 100 may apply an isolation and neutralization technique on the one or more EFB applications whose uncertified data 220 are compromised. In an example, the isolation and neutralization technique is a technique that restricts the EFB applications which are containing uncertified data 220 that are compromised. For example, the EFB application may be a weather forecast application that may contain a virus. Upon determination of the uncertified data obtained from the weather forecast application to be compromised data, the validation engine 106 may stop the working of the weather forecast application to restrict the receiving of the uncertified data from the weather forecast application. In another example, the validation engine 106 may restrict the receiving of the uncertified data by blocking connection, such as, by blocking IP address of the EFB 204 associated with the EFB application containing the compromised data. In yet another example, the validation engine 106 may delete the data received from the EFB 204 associated with the EFB application containing the compromised data. In another example, the validation engine 106 may provide a notification to the user and request the user to provide an input for performing certain operations, such as, deletion of compromised data, blocking on receiving data. The uncertified data 220 which are determined not to be compromised are further used along with the certified avionic data 222 received from the one or more avionics 202.

The flight parameter generation engine 108 calculates flight modification parameters based on the uncertified data 220 which are determined not to be compromised and the certified avionic data 222 received from the one or more avionics 202. The flight modification parameters optimize the operation and management of the aerial vehicle. For example, the flight parameter generation engine 108 may calculate flight modification parameters based on the uncertified data 220 which are not compromised, such as real-time weather data. Based on the real-time weather data and the certified avionic data received from the one or more avionics 202, such as flight management system (FMS), flight modification parameters are calculated to optimize the operation and management of the aerial vehicle. In an example, the flight modification parameters may comprise at least one of an increase in speed, a decrease in speed, an increase in altitude, a decrease in altitude, and a change in flight route of the aerial vehicle. The flight parameter generation engine 108 may transmit the flight modification parameters to the FMS of the aerial vehicle.

In an implementation of the present subject matter, the system 100 may restrict the one or more EFB applications from accessing at least a portion of the certified aviation data 222 from the one or more avionics 202 by apply a mask on at least a portion of the certified aviation data 222. In an exemplary situation, the EFB application, such as, average fuel performance application may access data about a flight trajectory in the particular flight route along with data, such as, data about flight paths, aircraft identifiers, distance to destination, and waypoints etc. The user may want to restrict the EFB application from accessing the data about flight trajectory for a particular flight route. In such a situation, masking of data that the user may want to restrict the EFB application from accessing is masked thereby allowing access to the EFB application only to at least a portion of the certified aviation data.

In operation, the masking engine 214 may receive certified aviation data 222 from the one or more avionics 202. The masking engine 214 may mask at least a portion of the certified aviation data 222 to provide controlled access of the certified aviation data 222 to the one or more EFB applications determined to be not compromised. The portion of the certified aviation data 222 may be masked using a masking technique. In an example, the masking technique may include, but is not limited to, pseudonymization, anonymization, lookup substitution, data redaction, and data shuffling. For example, the masking engine 214 may apply the technique “data shuffling” to restrict the one or more EFB applications from accessing the flight trajectory. In the data shuffling technique, the specific values of the certified avionic data, such as, flight paths, aircraft identifiers, distance to destination etc., are re-arranged thereby masking the original certified avionic data. In an example, the masking engine 214 may apply the masking technique on the certified aviation data 222 depending on one or more of security policies and monetary policies.

The masking ensures that only relevant portion of the certified aviation data 222 is available at the one or more EFB applications for processing. Further, the security of the certified aviation data 222 of the one or more avionics 202 is enhanced.

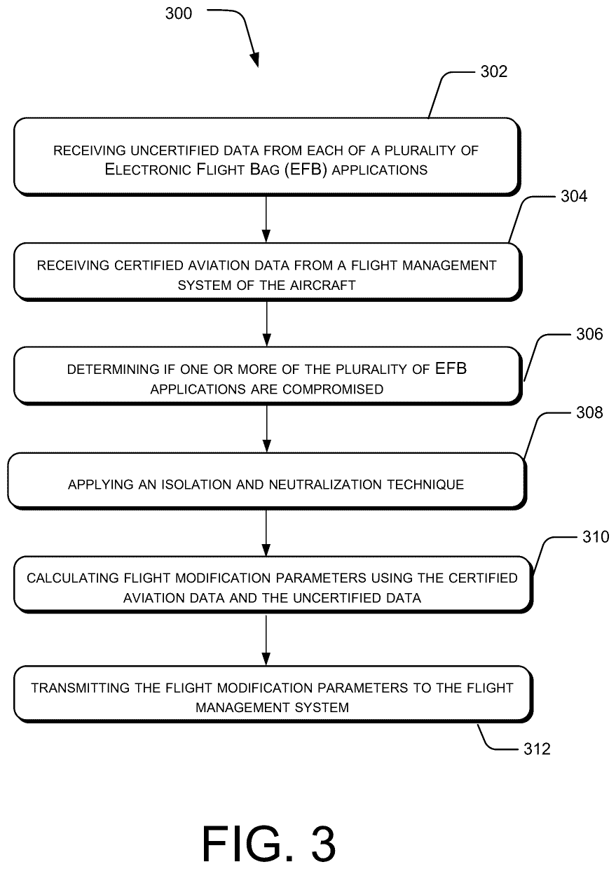

FIG. 3 illustrates a method 300 for managing security of data of EFB applications to be used with avionics, according to an example. The order in which the above-mentioned methods are described is not intended to be construed as a limitation, and some of the described method blocks may be combined in a different order to implement the method, or an alternative method.

Furthermore, the above-mentioned method may be implemented in a suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encode computer-executable instructions, where the instructions perform some or all the steps of the above-mentioned method.

Referring to FIG. 3, the method 300 may be implemented by a system for managing security of data of EFB applications to be used with avionics. The EFB applications may be similar to the EFB applications of FIG. 1. The avionics may be similar to the avionics of FIG. 1. The system may be similar to the system of FIG. 1.

At block 302, the method includes receiving uncertified data from each of a plurality of Electronic Flight Bag (EFB) applications. The uncertified data may be associated with at least one of flight assistance parameters of an aircraft. In an example, uncertified data may be a real-time weather data or a real-time planning data, which may be utilized by avionics of the aircraft to modify flight operation, such as adapting to an optimized flight route. In an example, the flight modification parameters include, but are not limited to, an increase in speed, a decrease in speed, an increase in altitude, a decrease in altitude, and a change in flight route. For example, considering a scenario where a passenger aircraft is scheduled to take-off and pilot of the passenger aircraft may have access to a portable device, i.e., an EFB. The portable device is connected to the internet, i.e., open source and may have versatile uncertified data in various EFB applications that may be useful for flight operations. Such uncertified data from various EFB applications may be received by the system 100.

At block 304, the method includes receiving certified aviation data from a flight management system of the aircraft. The aviation data obtained from avionics, i.e., flight management system 202 is authentic, because such aviation data is uploaded in the avionics after a series of authentication/verification processes. Thus, the aviation data obtained from the avionics is referred to as certified aviation data. In an example, aviation data may comprise at least one of a flight path, a traffic diversion status, minimum equipment list constraints, a cargo weight, and an estimate time of arrival of the aircraft at a stopover airport. The received certified aviation data may be kept handy to be used with the uncertified data of the EFB applications but prior to any collaboration of the certified aviation data and the uncertified data of the EFB applications, the authenticity of the uncertified data of the EFB applications needs to be validated.

At block 306, the method includes determining if one or more of the plurality of EFB applications are compromised. Such a determination if the one or more of the plurality of EFB applications are compromised may be carried out by performing a validity test on the uncertified data. In an example, the validity test on the uncertified data may be performed using a known validity testing process. The validity test is important because the data from the EFB applications are from open source and is not authenticated. Such open-source data is prone to contamination due to cyber threats, such as a malicious program, a virus, modified data, and/or any suspicious data. If this uncertified and contaminated data may badly affect the flight operations if used directly without any prior check. In an example, the validity test may be one of a startup test, a continuous test, and an interactive test.

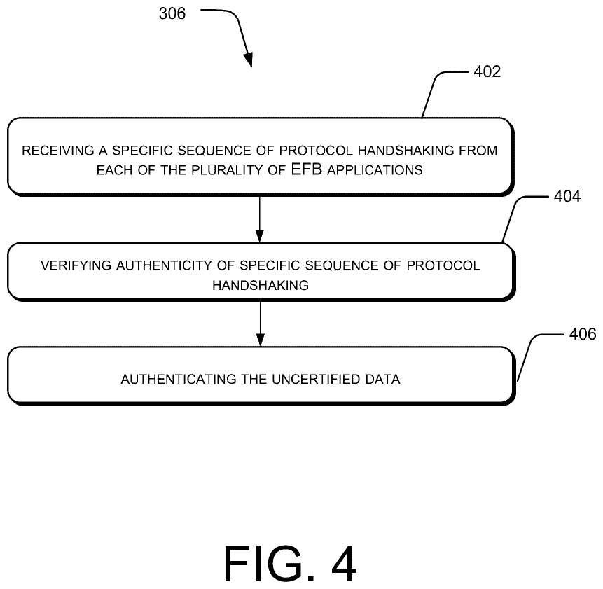

An example implementation is depicted in FIG. 4, where the validity test is performed on the uncertified data of the EFB applications.

At block 402, when the validity test is initiated, a specific sequence of protocol handshaking may be requested from the one or more EFB applications. Upon such a request, the specific sequence of protocol handshaking may be received from the one or more EFB applications. In an example, the specific sequence of protocol handshaking may be a transmission control protocol (TCP).

At block 404, authenticity of the specific sequence of protocol handshaking is verified. For example, a public key infrastructure (PKI) may be used and a shared symmetric key may be established between the parties, such as EFBs and Avionics, to ensure confidentiality and integrity of the uncertified data.

At block 406, the uncertified data of the EFB application is authenticated. Such an authentication may be based on the verification that the specific sequence of protocol handshaking was authentic, and the uncertified data is safe to use.

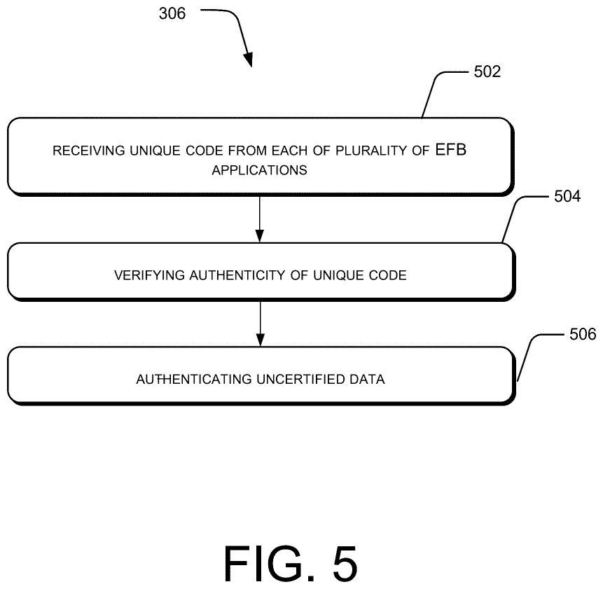

Further, an example implementation is depicted in FIG. 5, where the validity test is performed on the uncertified data of the EFB applications.

At block 502, a unique code may be received from each of the plurality of EFB applications. In an example, the unique code may be a one-time password having a specified validity timing. In an example, the unique code may be a fixed code that two parties can share amongst them for the authentication of any application or any device. In another example, the unique code may be a special code to establish the validity of the uncertified data.

At block 504, authenticity of the unique code may be verified. For example, the party issuing the unique code may compare the code entered by the other party and based on the comparison, the authenticity of the unique code may be verified. If the unique code matches with the code entered by the other party, the authenticity of the unique code may be marked as verified.

At block 506, the uncertified data of the EFB application is authenticated. Such an authentication may be based on the verification that the unique code was authentic, and the uncertified data is safe to use.

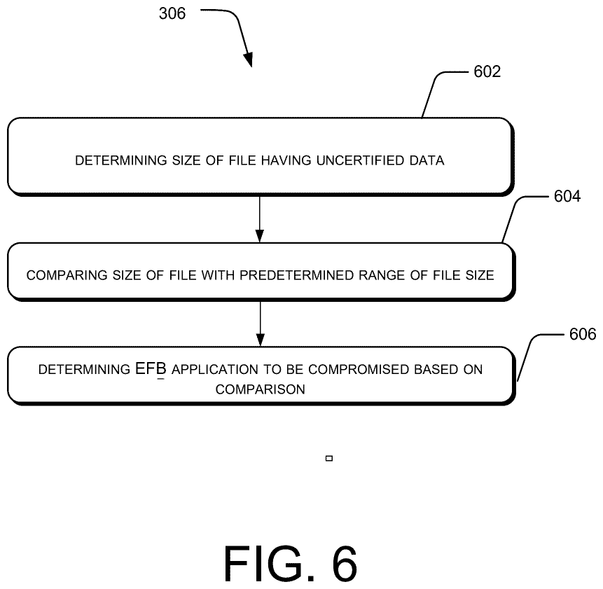

Further, an example implementation is depicted in FIG. 6, where the validity test is performed on the uncertified data of the EFB applications.

At block 602, size of each file having the uncertified data for each of the plurality of EFB applications may be determined. Such a determination may be done with conventionally known technique.

At block 604, the determined size of the file may be compared with a predetermined range of file size. For example, from a particular EFB application, such as weather update application, size of the file is commonly of 4 to 6 Megabytes, so the predetermined range of file size for this particular EFB application may be 4 to 6 Megabytes. For example, on comparison, if the file size is determined to be within the predetermined range of file size, the file is determined to be safe and can be used with the flight management system.

At block 606, based on the comparison, the EFB application may be determined to be compromised upon determining that the size of the file is not within the predetermined range of file size. In an example, if the file size if either 3 Megabytes or 7 Megabytes, the size of the file is not within the predetermined range of file size and therefore the EFB application may be marked as compromised and termination of the compromised EFB application may be planned.

Returning to block 306 of FIG. 3, if the validity test is a startup test, the determination of whether the uncertified data is compromised may initiate automatically when the uncertified data is received from any EFB application. In an example, if the validity test is a continuous test, the test is executed continuously and simultaneously operating the avionics with the EFB application, if any uncertified data of any EFB application is determined to be compromised during the continuous test, the particular EFB application may be terminated. In another example, if the validity test is an interactive test, the pilot of the aircraft may provide an input to initiate the validity test to determine if the uncertified data is compromised.

In an example, the setting of the validity test may be defined from one of a manual validation setting and an auto validation setting. In the manual validation setting, the validity test may be performed on receiving a prompt from the user. In the auto validation setting, the validity test may be performed automatically during a startup of a flight operation of the aerial vehicle.

At block 308, the method includes applying an isolation and neutralization technique for the compromised EFB applications. The isolation and neutralization technique ensures that the compromised EFB applications do not interact with the avionics and therefore any possible avionics data contamination is completely prevented. Thus, transmission of the compromised uncertified data to the flight management system of the aircraft is prevented. In addition, the isolation and neutralization technique does not hinder the interaction of the uncompromised EFB applications with the avionics which would have hindered if the conventional techniques have been used. In an example, the one or more EFB applications determined to be compromised may be terminated by the isolation and neutralization technique.

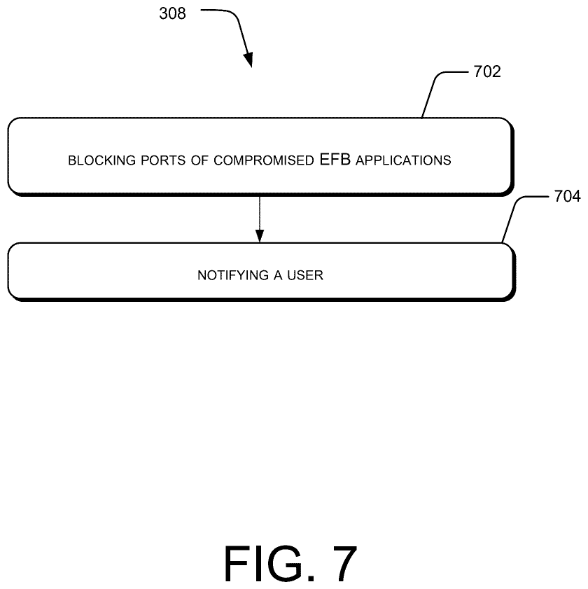

Further, an example implementation is depicted in FIG. 7, where the isolation and neutralization technique may be applied for the compromised EFB applications.

At block 702, ports of the EFB application(s) determined to be compromised are blocked. For the blocking, internet traffic by the combination of port number and transport protocol of the compromised EFB application(s) may be identified and further the same may be blocked so that the internet traffic does not reach to the avionics.

At block 704, the user may be notified that the ports of which EFB application is blocked so that in case of the manual setting, the user may be careful with next time usage of the EFB application being blocked and may issue a prompt at the outset of the aerial vehicle operation to apply the validation test on the EFB application having a blocking history. In an example, the user may be the pilot of the aerial vehicle. In an example, the user may be the crew member seated at a backend office of service provider of an airline managing the aerial vehicle.

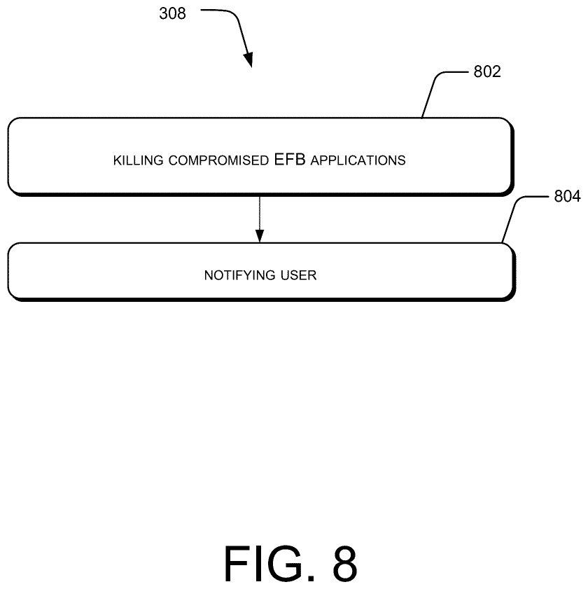

Further, an example implementation is depicted in FIG. 8, where the isolation and neutralization technique may be applied for the compromised EFB applications.

At block 802, the EFB application(s) determined to be compromised may be killed. For the killing, the compromised EFB application(s) may be permanently deleted from the EFB.

At block 804, the user may be notified that a particular compromised EFB application is killed and is not available for onward usage. In an example, the user may be notified before killing of the compromised EFB application(s) and the killing may be terminated if such a request is prompted from the user.

Returning to FIG. 3, at block 310, the method includes calculating flight modification parameters. The flight modification parameters may be calculated using the certified aviation data received from the flight management system of the aerial vehicle and the uncertified data of the one or more EFB applications determined to be not compromised. The uncertified data of the compromised EFB applications is not considerable for the calculation of the flight modification parameters. In an example, the flight modification parameters may be one or more of an increase in speed, a decrease in speed, an increase in altitude, a decrease in altitude, and a change in flight route. The flight modification parameters are calculated so that the operation and management of the aerial vehicle can be optimized. For example, a real-time navigational chart may help in optimizing the flight route of the aerial vehicle, on ascertaining that the real-time navigational chart is received from a safe EFB application, the same may be used along the certified aviation data, for example, already present coordinates of the flight route for calculating a modified flight route.

At block 312, the method includes transmitting the flight modification parameters to the flight management system of the aircraft. In an example, the modified flight route, i.e., the flight modification parameter may be transmitted to the avionics, i.e., the flight management system either automatically or when prompted by the pilot of the aerial vehicle. After the transmission, the flight management system of the aerial vehicle may utilize the flight modification parameter for further operation of the aerial vehicle.

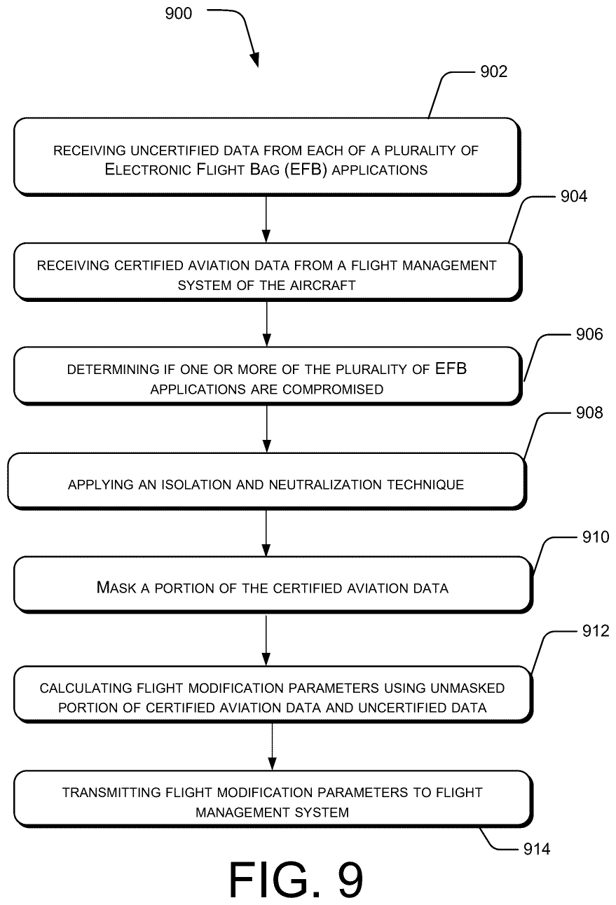

FIG. 9 illustrates a method 900 for managing security of data of EFB applications to be used with avionics, according to an example. The order in which the above-mentioned method is described is not intended to be construed as a limitation, and some of the described method blocks may be combined in a different order to implement the method, or an alternative method.

Furthermore, the above-mentioned method may be implemented in a suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encode computer-executable instructions, where the instructions perform some or all the steps of the above-mentioned method.

Referring to FIG. 9, the method 900 may be implemented by a system for managing security of data of EFB applications to be used with avionics. The EFB applications may be similar to the EFB applications of FIG. 1. The avionics may be similar to the avionics of FIG. 1. The system may be similar to the system of FIG. 1.

At block 902, steps similar to block 302 of FIG. 3 are performed, where the method includes receiving uncertified data from each of a plurality of Electronic Flight Bag (EFB) applications.

At block 904, steps similar to block 304 of FIG. 3 are performed, where the method includes receiving certified aviation data from a flight management system of the aircraft.

At block 906, steps similar to block 306 of FIG. 3 are performed, where the method includes determining if one or more of the plurality of EFB applications are compromised. Such a determination if the one or more of the plurality of EFB applications are compromised may be carried out by performing a validity test on the uncertified data.

At block 908, steps similar to block 308 of FIG. 3 are performed, where the method includes applying an isolation and neutralization technique for the compromised EFB applications. The isolation and neutralization technique ensures that the compromised EFB applications do not interact with the avionics and therefore any possible avionics data contamination is completely prevented. Thus, transmission of the compromised uncertified data to the flight management system of the aircraft is prevented.

At block 910, the method includes masking, using a masking technique, at least a portion of the certified aviation data to provide controlled access of the certified aviation data to the one or more EFB applications determined to be not compromised. In an example, the masking technique may include, but is not limited to, pseudonymization, anonymization, lookup substitution, data redaction, and data shuffling. For example, the “data redaction” may be applied to restrict the one or more EFB applications from accessing the flight trajectory. In the data redaction technique, the portion of the certified avionic data not usable by a particular EFB application is redacted so that the not usable certified data is not misused. The masking ensures that only relevant portion of the certified aviation data is available at the EFB applications for further processing. This further enhances the security of the certified aviation data of the flight management system, i.e. avionics. In an example, the masking technique may be applied appropriately based on policies on data before giving the data to client applications, i.e., EFB applications.

In an example, a critical EFB application may need accurate real time values of sensitive information like fuel left in the aerial vehicle, distance to destination at every waypoint. But another EFB application, which is collecting information to arrive at average fuel performance for a given flight distance, waypoint can be changed to something else using “Lookup substitution” techniques. In such a case, “data shuffling” technique may be used to still keep the values distance to destination and waypoints but can be shuffle the assignments between them so that someone who is collecting that may not be able to figure out the actual trajectory of the flight.

In another example, a flight plan data set might have contain some IP protected datasets which is useful for a company specific application but the company do not want to expose those datasets to a third party EFB application suppliers. But if those datasets are removed then the flight plan may look visibly incomplete. So, in such cases, “data redaction” technique may be used by replacing the IP protected data with a constant like “XXX-XXXXXX-XX”.

At block 912, the flight modification parameters may be calculated using unmasked portion of certified aviation data received from the flight management system of the aerial vehicle and the uncertified data of the one or more EFB applications determined to be not compromised. Since only the unmasked portion of certified aviation data is utilized for flight modification parameters calculation, any threat of unwanted usage of the certified aviation data is obviated.

At block 914, steps similar to block 312 of FIG. 3 are performed, where the method includes transmitting the flight modification parameters to the flight management system of the aircraft.

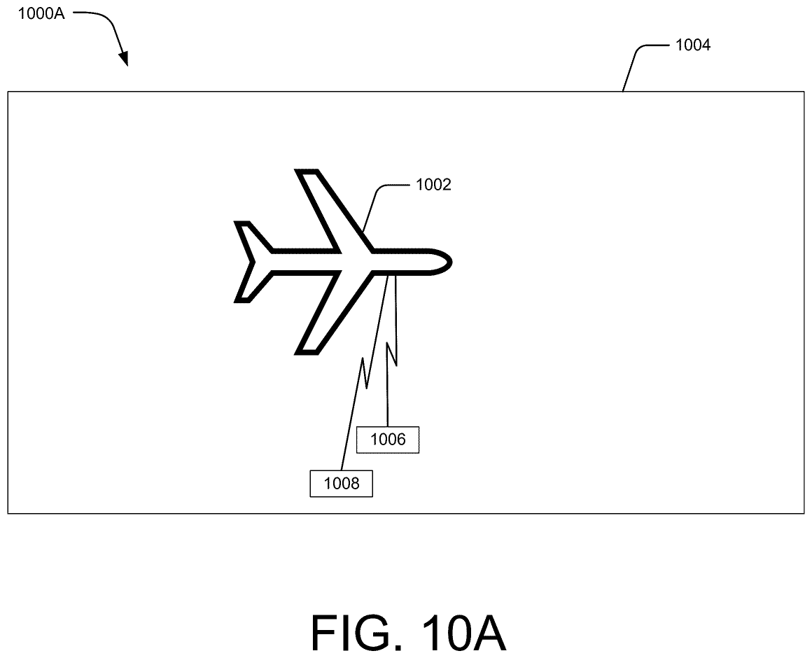

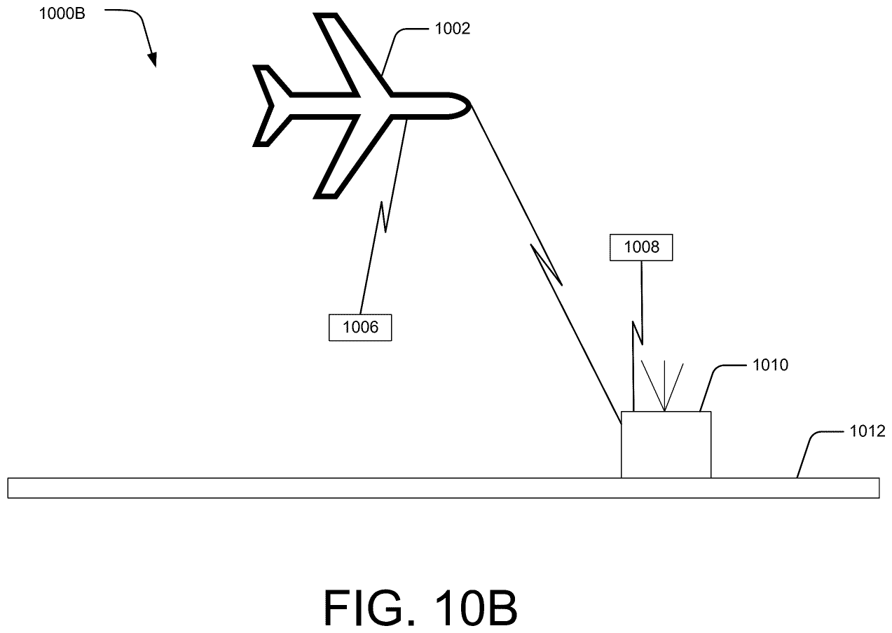

FIG. 10A depicts an environment 1000A where an aircraft 1002 is at a runway 1004 before takeoff, according to an example. Firstly, in this environment 1000A, in an example, a system (now shown here) which is similar to the system 100 may begin with receiving from a flight management system 1006 disposed onboard of the aircraft, real-time flight data. The real-time flight data may comprise at least one of the predicted fuel available in the aircraft when the aircraft lands, the predicted weight of the aircraft when the aircraft lands, any jettison or anomalous fuel quantity which would affect the predicted fuel level and the weight of the aircraft, the fuel flow data between the left and right pumps as desired by the crew, the predicted estimated time of arrival (ETA) of the aircraft at a stopover airport, any unplanned diversion from original flight path by the crew due to weather, traffic or other issues, and any minimum equipment list (MEL) constraints developed by the enroute aircraft. The real-time flight data is certified data.

Further, the system may then initiate receiving from third party data sources 1008, real-time weather and/or traffic data for the flight path of the aircraft. The third party data sources 1008 are open sources and are like the EFB applications. Before transmitting the real-time weather and/or traffic data to the flight management system 1006, authenticity of the third party data sources 1008 may be verified by performed a validity test with similar process as depicted in FIGS. 3 and 9. If the third party data sources 1008 are not authenticated, i.e., the real-time weather and/or traffic data is contaminated, the third party data sources 1008 may be isolated and neutralized. In an example, if all the third party data sources 1008 are not authenticated, all the third party data sources 1008 may be terminated. In an example, if some of the third party data sources 1008 are not authenticated, only the unauthenticated third party data sources 1008 may be terminated and data of the remaining authenticated third party data sources 1008 may be passed on to the flight management system 1006. The real-time flight data and the real-time weather and/or traffic data received from the authenticated third party data sources 1008 may then be input into a simulation engine (not shown) to calculate any flight modification parameters. Once the simulation is completed, then any flight modification parameters may be transmitted to the aircraft crew via a communication link to the flight management system 1006 where appropriate flight changes may be made to the enroute aircraft.

FIG. 10B depicts an environment 1000B where the aircraft 1002 is flying and simultaneously interacting with a ground fleet service platform 1010 located at ground 1012, according to an example. Firstly, in this environment 1000B, in an example, a system (now shown here) which is similar to the system 100 may begin with receiving from the flight management system 1006 disposed onboard the aircraft, real-time flight data. The real-time flight data is the certified data.

Further, the system may then initiate receiving from third party data sources, real-time weather and/or traffic data for the flight path of the aircraft at the ground fleet service platform 1010. The third party data sources are open sources and are like the EFB applications. Before transmitting the real-time weather and/or traffic data to the flight management system 1006, authenticity of the third party data sources 1008 may be verified by performed a validity test with similar process as depicted in FIGS. 3 and 9. If the third party data sources 1008 are not authenticated, i.e., the real-time weather and/or traffic data is contaminated, the third party data sources 1008 may be isolated and neutralized. In an example, if all the third party data sources 1008 are not authenticated, all the third party data sources 1008 may be terminated. In an example, if some of the third party data sources 1008 are not authenticated, only the unauthenticated third party data sources 1008 may be terminated and data of the remaining authenticated third party data sources 1008 may be passed on to the flight management system 1006 via the ground fleet service platform 1010. Furthermore, real-time planning data may be received from the ground fleet service platform 1010. The real-time flight data, the real-time weather and/or traffic data received from the authenticated third party data sources 1008, and the real-time planning data may then be input into a simulation engine (not shown) to calculate any flight modification parameters. Once the simulation is completed, then any flight modification parameters may be transmitted to the aircraft crew via a communication link to the flight management system 1006 where appropriate flight changes may be made to the enroute aircraft.

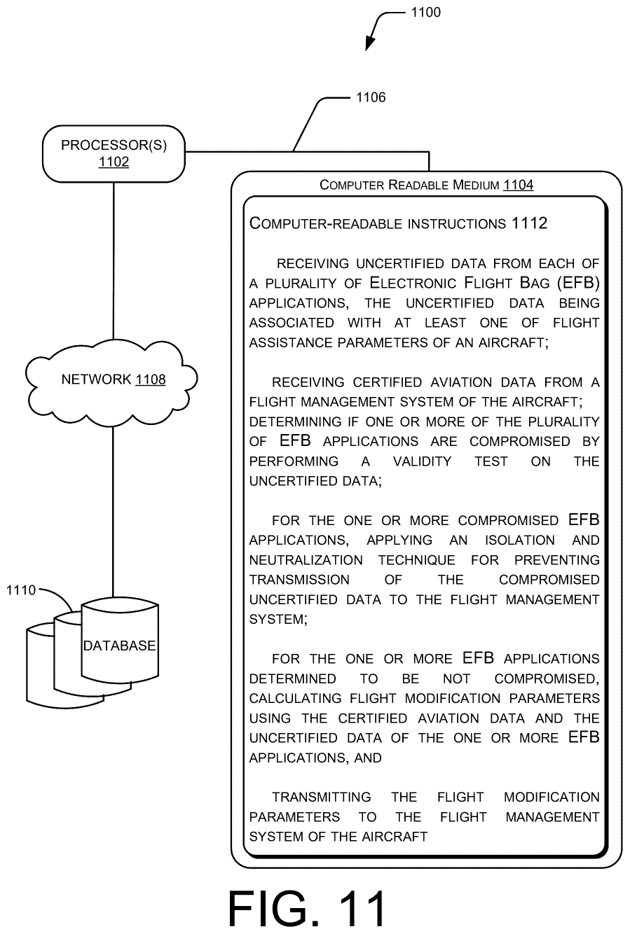

FIG. 11 illustrates a system environment 1100 implementing a non-transitory computer readable medium for managing security of data of EFB applications to be used with avionics, according to an example. In an example, the system environment 1100 includes processor(s) 1102 communicatively coupled to a non-transitory computer readable medium 1104 through a communication link 1006. In an example, the processor(s) 1102 may have one or more processing resources for fetching and executing computer-readable instructions from the non-transitory computer readable medium 1104. The processor(s) 1102 and the non-transitory computer readable medium 1004 may be implemented, for example, in the system 100 (as has been described in conjunction with the preceding figures).

The non-transitory computer readable medium 1104 may be, for example, an internal memory device or an external memory device. In an example implementation, the communication link 1106 may be a network communication link. The processor(s) 1102 may access the non-transitory computer readable medium 1104 through a network 1108. The network 1108 may be a single network or a combination of multiple networks and may use a variety of communication protocols. The processor(s) 1102 and the non-transitory computer readable medium 1104 may also be communicatively coupled to a data source 1110 over the network 1108. The data source 1110 may include, for example, a database.

In an example implementation, the non-transitory computer readable medium 1104 includes a set of computer readable instructions (hereinafter may also be referred as instructions) 1112 which may be accessed by the processor(s) 1102 through the communication link 1006. Referring to FIG. 11, in an example, the non-transitory computer readable medium 1104 includes instructions 1112 that may cause the processor(s) 1102 to receive the uncertified data from each of the EFBs and to receive certified aviation data from a flight management system of the aircraft. The uncertified data may be associated with a flight assistance parameter of an aircraft. The certified aviation data may be one of a flight path, a traffic diversion status, minimum equipment list constraints, a cargo weight, and an estimate time of arrival of the aircraft at a stopover airport. Upon receiving the uncertified data, the instructions 1112 may cause the processor(s) 1102 to perform a validity test, selecting one or more of a startup test, a continuous test, and an interactive test, on the uncertified data to determine if the uncertified data is compromised, i.e., includes a malicious program, a virus, modified data, and/or any suspicious data. In an example, the validation engine, during the validity test, may compare file size of the uncertified data received from the plurality of EFBs with a predetermined file size. For example, during the validity test, the instructions 1112 may cause the processor(s) 1102 to determine a file size of a document having the uncertified data for each of the plurality of EFB applications and further compare the determined file size with a predetermined range of file size. The instructions 1112 may cause the processor(s) 1102 to determine the EFB application to be compromised when the file size is not within the predetermined range of file size.

Upon determining that the uncertified data from the one or more EFB applications are compromised, the instructions 1112 may cause the processor(s) 1102 to apply an isolation and neutralization technique on the one or more EFB applications whose uncertified data are compromised. In an example, the isolation and neutralization technique may be a technique that stops the one or more EFB applications which are containing uncertified data that are compromised. For example, the EFB application may be a weather forecast application that may contain a virus. Upon determination of the uncertified data obtained from the weather forecast application to be compromised data, the working of the weather forecast application may be terminated to restrict the receiving of the uncertified data from the weather forecast application.

The instructions 1112 may further cause the processor(s) 1102 to calculate flight modification parameters based on the uncertified data which are determined not to be compromised and the certified avionic data received from the one or more avionics. The flight modification parameters optimize the operation and management of the aerial vehicle. In an example, the flight modification parameters may include at least one of an increase in speed, a decrease in speed, an increase in altitude, a decrease in altitude, and a change in flight route of the aerial vehicle. The instructions 1112 may further cause the processor(s) 1102 to transmit the flight modification parameters to the flight management system of the aerial vehicle so that the aerial vehicle may operate in an optimized manner.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

We claim:

1. A method comprising:
receiving uncertified data from each of a plurality of Electronic Flight Bag (EFB) applications, the uncertified data being associated with at least one of flight assistance parameters of an aircraft;
receiving certified aviation data from a flight management system of the aircraft;
determining if one or more of the plurality of EFB applications are compromised by performing a validity test on the uncertified data;
for the one or more compromised EFB applications, applying an isolation and neutralization technique for preventing transmission of the compromised uncertified data to the flight management system of the aircraft;
for the one or more EFB applications determined to be not compromised, calculating flight modification parameters using the certified aviation data and the uncertified data of the one or more EFB applications; and
transmitting the flight modification parameters to the flight management system of the aircraft.

2. The method as claimed in claim 1, wherein the performing of the validity test comprises:
receiving a specific sequence of protocol handshaking from each of the plurality of EFB applications;
verifying authenticity of the specific sequence of protocol handshaking; and
authenticating the uncertified data of the EFB application based on the verification.

3. The method as claimed in claim 1, wherein the performing of the validity test comprises:
receiving a unique code from each of the plurality of EFB applications;
verifying authenticity of the unique code; and
authenticating the uncertified data of the EFB application based on the verification.

4. The method as claimed in claim 1, wherein the performing of the validity test comprises:
determining a validation setting, the validation setting being one of a manual validation setting and an auto validation setting;
for the validation setting being the manual validation setting, performing the validity test on receiving a prompt from a user; and
for the validation setting being the auto validation setting, performing the validity test automatically during a startup of a flight operation of the aircraft.

5. The method as claimed in claim 1, wherein the validity test is one of a startup test, a continuous test, and an interactive test.

6. The method as claimed in claim 1, wherein the applying of the isolation and neutralization technique comprises terminating the one or more EFB applications determined to be compromised.

7. The method as claimed in claim 1, wherein the applying of the isolation and neutralization technique comprises:
blocking ports of the one or more EFB applications determined to be compromised; and
notifying a user about the blocked ports.

8. A system comprising:
a validation engine to:
receive uncertified data from each of a plurality of Electronic Flight Bag (EFB) applications, the uncertified data being associated with at least one of flight assistance parameters of an aircraft; and
determine if one or more of the plurality of EFB applications are compromised by performing a validity test on the uncertified data;
for the one or more compromised EFB applications, apply an isolation and neutralization technique for preventing transmission of the compromised uncertified data to a flight management system of the aircraft; and
a masking engine to:
receive certified aviation data from the flight management system of the aircraft; and
mask, using a masking technique, at least a portion of the certified aviation data to provide controlled access of the certified aviation data to the one or more EFB applications determined to be not compromised; and
a flight parameter generation engine to:
calculate flight modification parameters using unmasked portion of the certified aviation data and the uncertified data.

9. The system as claimed in claim 8, wherein the flight parameter generation engine to transmit the flight modification parameters to the flight management system of the aircraft.

10. The system as claimed in claim 8, wherein the validation engine is to:
receive a specific sequence of protocol handshaking from each of the plurality of EFB applications;
verify authenticity of the specific sequence of protocol handshaking; and
authenticate the uncertified data of the EFB application based on the verification.

11. The system as claimed in claim 8, wherein the validation engine is to:
receive a unique code from each of the plurality of EFB applications;
verify authenticity of the unique code; and
authenticate the uncertified data of the EFB application based on the verification.

12. The system as claimed in claim 8, wherein the validation engine is to terminate the one or more EFB applications determined to be compromised.

13. The system as claimed in claim 8, wherein the validation engine is to:
block ports of the one or more EFB applications determined to be compromised; and
notify a user about the blocked ports.

14. The system as claimed in claim 8, wherein the masking technique is one of a pseudonymization masking technique, an anonymization masking technique, a lookup substitution masking technique, a data shuffling masking technique, and a data redaction masking technique.

15. The system as claimed in claim 8, wherein the masking engine is to apply the masking technique on the certified aviation data depending on one or more of security policies and monetary policies.

16. The system as claimed in claim 8, wherein the flight management system of the aircraft is at least one of an onboard flight management system located onboard the aircraft or a remote flight management system located remotely from the aircraft, and the certified aviation data is received from at least one of the onboard flight management system onboard or the remote flight management system.

17. A non-transitory computer readable medium having instructions stored thereon, the instructions, when executed by a processor, cause the processor to perform operations comprising:
receiving uncertified data from each of a plurality of Electronic Flight Bag (EFB) applications, the uncertified data being associated with at least one of flight assistance parameters of an aircraft;
receiving certified aviation data from a flight management system of the aircraft;
determining if one or more of the plurality of EFB applications are compromised by performing a validity test on the uncertified data;
for the one or more compromised EFB applications, applying an isolation and neutralization technique for preventing transmission of the compromised uncertified data to the flight management system;
for the one or more EFB applications determined to be not compromised, calculating flight modification parameters using the certified aviation data and the uncertified data of the one or more EFB applications, and
transmitting the flight modification parameters to the flight management system of the aircraft.

18. The non-transitory computer readable medium as claimed in claim 17, wherein the non-transitory computer readable medium comprises:
determining size of a file having the uncertified data for each of the plurality of EFB applications;
comparing the size of the file with a predetermined range of file size; and
upon determining that the size of the file is not within the predetermined range of file size, determining the EFB application to be compromised.

19. The non-transitory computer readable medium as claimed in claim 17, wherein the certified aviation data comprises at least one of a flight path, a traffic diversion status, minimum equipment list constraints, a cargo weight, and an estimate time of arrival of the aircraft at a stopover airport.

20. The non-transitory computer readable medium as claimed in claim 17, wherein the flight modification parameters comprise at least one of an increase in speed, a decrease in speed, an increase in altitude, a decrease in altitude, and a change in flight route.
